(19) United States
(12) Patent Application Publication
(10) Pub. No.: US 2026/0070019 A1
(43) Pub. Date: Mar. 12, 2026

(54) ADAPTIVE 3D-PRINTED REVERSE OSMOSIS MEMBRANE MANUFACTURING SYSTEM

(71) Applicant: INTERNATIONAL BUSINESS MACHINES CORPORATION, ARMONK, NY (US)

(72) Inventors: Jessica Nahulan, Markham (CA); Sarbajit Kumar Rakshit, Kolkata (IN); Heather Nicole Polgrean, Lagrangeville, NY (US); Carolina Garcia Delgado, Zapopan (MX)

(21) Appl. No.: 18/829,484

(22) Filed: Sep. 10, 2024

(51) Int. Cl. B01D 61/12; B01D 61/02; B01D 61/08; B33Y 10/00; B33Y 50/02

(52) U.S. Cl. CPC B01D 61/12; B01D 61/025; B01D 61/08; B33Y 10/00; B33Y 50/02; B01D 2313/18; B01D 2313/60; B01D 2313/702

(57) ABSTRACT

According to one embodiment, a method, computer system, and computer program product for manufacturing a semi-permeable membrane for purifying a fluid through reverse osmosis is provided. The present invention may include calculating a shear stress exerted by the simulated fluid on semi-permeable membrane configurations; generating a membrane design for the semi-permeable membrane based on the modeling, wherein the membrane design comprises a material selected based on the calculated shear stress; and manufacturing a semi-permeable membrane of the selected material using a 3D printer, based on the membrane design.

### BACKGROUND

The present invention relates, generally, to the field of computing, and more particularly to fluid purification.

The field of fluid purification may be the technological field concerned with the hardware, software, and processes for removing contaminants, such as undesirable chemicals, biological contaminants, suspended solids, and gases, from fluids in order to render the fluid suitable for specific purposes, such as purifying water for human consumption. Widely varied techniques are available to remove contaminants such as fine solids, micro-organisms, dissolved inorganic and organic materials, and environmental persistent pharmaceutical pollutants; the choice of method will depend on the quality of the water being treated, the cost of the treatment process and the quality standards expected of the processed water. One such method is that of reverse osmosis, which is a separation process which relies on a semipermeable membrane that allows the passage of solvent molecules (usually water) while blocking the passage of dissolved ions, molecules, and particulate matter.

### SUMMARY

According to at least one embodiment, a method and computer program product for manufacturing a semi-permeable membrane for purifying a fluid through reverse osmosis is provided. The present invention may include calculating a shear stress exerted by the simulated fluid on semi-permeable membrane configurations; generating a membrane design for the semi-permeable membrane based on the modeling, wherein the membrane design comprises a material selected based on the calculated shear stress; and manufacturing a semi-permeable membrane of the selected material using a 3D printer, based on the membrane design.

According to at least one embodiment, a computer system for performing a fluid purification task using a semi-permeable membrane for reverse osmosis is provided. The present invention may include one or more sensors disposed within a fluid channel comprising one or more valves, one or more semi-permeable membranes, one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising: monitoring, by the one or more sensors, a plurality of fluid properties and flow characteristics of a fluid flowing through the fluid channel in real time; calculating, based on the fluid properties and flow characteristics, a shear stress exerted on the semi-permeable membrane by the fluid in real time; and responsive to the shear stress falling outside of a stress threshold, operating the one or more valves to alter the flow characteristics to raise or lower the shear stress to fall within the stress threshold.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a reverse osmosis manufacturing process according to at least one embodiment; and

FIG. 3 illustrates an exemplary reverse osmosis system according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to fluid purification. The following described exemplary embodiments provide a system, method, and program product to, among other things, determine membrane properties which a semi-permeable membrane must possess to perform a fluid purification task, design a non-permeable membrane possessing the necessary membrane properties, and 3D-print a customized membrane based on the design.

As previously described, fluid purification may be the technological field concerned with the hardware, software, and processes for removing contaminants from fluids, and may encompass methods utilizing reverse osmosis; reverse osmosis is commonly employed to produce purified water, desalinate seawater, treat wastewater, and remove impurities from various liquid solutions. In addition to water purification, reverse osmosis has various applications in any industries and processes where the removal of impurities or concentration of certain substances from fluids is required. For example, notable use cases for reverse osmosis may include:

Wastewater Treatment: Reverse osmosis can be employed in wastewater treatment to remove contaminants and pollutants, enabling the reuse or safe discharge of treated water.

Food and Beverage Concentration: Reverse osmosis can be used to concentrate liquids, such as fruit juices, to increase their flavour and shelf life while reducing transport costs.

Pharmaceutical Manufacturing: Reverse osmosis is crucial in pharmaceutical production for concentrating and purifying substances used in drug formulations.

Mining: Reverse osmosis is used for the purification and concentration of mining solutions, especially in the extraction of minerals and metals.

Chemical Separations: Reverse osmosis aids in separating and purifying various chemicals in the chemical industry, such as the separation of solvents from solutes.

Power Plant Cooling Water: Reverse osmosis is used for treating cooling water in power plants to prevent scaling and fouling in heat exchangers, which can affect efficiency.

High-Purity Solvent Production: Reverse osmosis can be employed to produce high-purity solvents used in analytical chemistry and laboratory applications.

Reverse osmosis is a separation process which relies on a semipermeable membrane that allows the passage of solvent molecules (usually water) while blocking the passage of dissolved ions, molecules, and particulate matter. In forward, or regular, osmosis, a solvent moves from an area of low solute concentration through a membrane to an area of high solute concentration. The driving force behind the movement of the solvent across the semipermeable membrane is osmotic pressure, which is a measure of the tendency of water to move into a solution due to its solute concentration. The osmotic pressure reduces as the solvent moves into the more concentrated solution, until the solute concentrations on each side of the membrane are equivalent. In reverse osmosis, on the other hand, an external pressure is applied to the fluid, overcoming the osmotic pressure and forcing the inlet fluid through the semipermeable membrane while blocking and trapping impurities. The purified fluid, known as the permeate, is collected on one side of the membrane, while the concentrated impurities, known as the reject or brine, are discharged.

Reverse osmosis is not typically used for the purification of solids; however, while reverse osmosis may not be used to purify solids directly, other separation and purification techniques, such as particle filtration and centrifugation, are available which may be more suitable for solid-liquid separation and the purification of solid materials. These techniques are often employed in industries such as mining, chemical processing, and food production to separate solids from liquids or purify solid materials.

Reverse osmosis differs fundamentally from particle filtration; particle filtration is a physical separation process that separates solid matter and fluid from a mixture using a filter medium with a complex structure that allows a fluid to pass but which physically blocks the passage of solid particles. The predominant removal mechanism in particle filtration is straining, or size exclusion, which targets particles in the fluid and which therefore requires a semipermeable membrane comprising pores that are 0.01 micrometers or larger, to efficiently catch particles without sacrificing flow rate. Conversely, the predominant removal mechanism for reverse osmosis utilizes differences in solubility or diffusivity, and reverse osmosis differs from filtration in that the mechanism of the fluid flow is reversed as the solvent crosses the membrane, leaving the solute behind; additionally, reverse osmosis differs from particle filtration in that reverse osmosis involves solvent diffusion across a membrane that is either nonporous or uses nanofiltration with pores 0.001 micrometers in size or smaller to ensure that only water particles can pass through, ensuring a fine filtration.

A crucial component in any system utilizing reverse osmosis is the semipermeable membrane. The semipermeable membrane is a thin sheet of material, or multiple sheets of material laminated or otherwise layered together, which comprise a number of tiny holes, or pores, through which fluid may pass but contaminants may not. The semipermeable membrane may be shaped and sized within a pipe or other fluid conduit to seal against the sides of the conduit, and thereby prevent fluid and contaminants from bypassing the membrane as it flows through the conduit. Key properties and characteristics of a semipermeable membrane for reverse osmosis may include the following:

Pore Size: Reverse osmosis membranes may comprise extremely small pores, typically in the range of 0.0001 to 0.001 micrometres (μm). The small pore size allows the membrane to block the passage of most contaminants and ions while permitting the passage of water molecules.

Selectivity: Reverse osmosis membranes are highly selective, allowing water molecules to pass through while rejecting dissolved salts, minerals, organic compounds, and particulate matter. This selectivity is vital for the purification process.

Surface Area: The effective surface area of the membrane is essential for water purification. Membranes with a larger surface area can handle larger volumes of water, making them suitable for industrial and large-scale applications.

Chemical Resistance: Reverse osmosis membranes must be chemically resistant to withstand exposure to different water sources, cleaning agents, and potential fouling substances. Chemical resistance ensures the membrane's durability.

Mechanical Strength: Reverse osmosis membranes should possess mechanical strength to withstand the high pressures involved in the reverse osmosis process without rupturing or deforming.

Reverse osmosis membranes are typically made from synthetic polymer materials. There are many suitable synthetic polymer materials that may be used in a reverse osmosis membrane; each synthetic polymer material has its own set of physical and chemical properties which may render the material more or less suited for towards any given fluid purification task, and choice of membrane material may therefore depend on the specific requirements of the function that the reverse osmosis system is expected to perform. In practice, polyamide thin-film composite membranes may be the most widely used material for their high efficiency and durability in water purification and desalination applications, but many other materials may be employed to produce reverse osmosis membranes, including, for example, the following:

Cellulose Acetate (CA): Cellulose acetate membranes were among the first materials used for reverse osmosis membranes. They are less common today due to lower salt rejection and durability compared to newer materials.

Polyamide (PA): Thin-film composite (TFC) membranes are made from a polyamide layer deposited on a porous support layer. PA-TFC membranes are widely used in modern reverse osmosis systems due to their high salt rejection and durability.

Polyethersulfone (PES): PES is a thermoplastic polymer used in some reverse osmosis membranes. It offers good chemical resistance and is suitable for applications that require higher operating temperatures.

Polysulfone (PS): Polysulfone membranes are known for their thermal stability and are used in specialized reverse osmosis applications.

Polypropylene (PP): Polypropylene is used in the construction of some reverse osmosis membranes due to its resistance to chemical attack and fouling.

Polyvinylidene Fluoride (PVDF): PVDF is another material used in reverse osmosis membranes, known for its resistance to chemicals and temperature variations.

Polytetrafluoroethylene (PTFE): PTFE membranes are highly chemically resistant and can be used in specific reverse osmosis applications.

Polycarbonate (PC): Polycarbonate membranes are less common but are suitable for certain applications.

Reverse osmosis systems may be required to perform tasks with a highly variable range of parameters; any given task may require a specific combination of membrane properties, such as physical size and shape, thickness, pore size, selectivity, surface area, chemical resistance, mechanical strength, et cetera, of a semipermeable membrane. If a membrane lacks the necessary membrane properties to carry out the fluid purification task, the membrane may fail to achieve the desired performance and may even degrade or rupture prematurely. For example, if the pore size of a membrane is too large, the membrane may allow contaminants to pass through, but if the pore size is too small, the membrane may reduce the flow rate or processing throughput to below desired levels, and may cause a backup in feed fluid which may cause overflowing or additional flow pressure. If strength and/or thickness of the membrane is insufficient, the shear stress exerted by the fluid on the membrane may cause the membrane to rupture, rendering the system unable to perform the fluid purification task until the membrane is replaced. If the membrane material is not tolerant to certain chemicals present in the fluid, such as chlorine or chloramines, chemicals such as oxidizers may burn holes in the membrane pores and cause irreparable damage. Conversely, a membrane that meets or exceeds the required membrane properties based on the task characteristics may achieve desired performance, longevity, and quality.

As such, equipping reverse osmosis systems with permeable membranes tailored to the requirements of the task they are expected to perform stands to yield considerable advantages in performance, longevity, efficiency, et cetera. However, calculating the membrane properties required for a system performing a given fluid purification task is difficult and time consuming. The membrane properties may be inferred, for example, from task characteristics such as the chemical and/or physical properties of the solvent, the chemical and/or physical properties of the contaminants that the system is expected to separate out, the flow rate and volume of fluids to be processed, environmental characteristics within which the reverse osmosis system is operating, the desired quality of the purification, desired performance of the reverse osmosis system, et cetera. Many task characteristics, such as chemical composition of the fluid and/or the solvent, temperature, concentration, et cetera, require dedicated hardware and software to determine.

Furthermore, even where membrane properties are known, acquiring a membrane possessing the membrane properties constitutes a significant challenge; traditional reverse osmosis membrane manufacturing is monolithic, and lacks the customizability and granularity to deliver membrane properties based on the requirements of a particular task. While specialized tailored membranes do exist for various applications, they lack dynamic adaptability. Three-dimensional printing methods may be used to address this deficiency; using 3D-printing methods, reverse osmosis membranes of any shape, size, thickness, pore size, material, et cetera may be manufactured on a per-task basis, which may be individually tailored to the task criteria.

As such, it may be advantageous to, among other things, implement a system that can utilize integrated sensors, machine learning, and computer simulation to provide real-time data processing, dynamic fluid property analysis, computational fluid dynamics modeling, and membrane stress analysis to synthesize task characteristics into a set of membrane properties. It may further be advantageous to operate a 3D-printer to manufacture a reverse osmosis membrane based on the membrane properties. Therefore, such a system would have the capacity to improve the technical field of fluid purification by improving the quality of reverse osmosis membranes, and yielding, for example, the following advantages:

Enhanced Water Purity: The ability of such a system to adaptively produce reverse osmosis membranes based on fluid characteristics stands to improve the quality of semipermeable membranes. Improved membrane quality results in higher water purity levels. This is crucial for industries such as pharmaceuticals, electronics manufacturing, and food and beverage, where high-purity water is essential for production processes. Membranes of sufficient quality designed with such a system could be used to remove impurities from water without the use of chemicals, improving the quality of water that previously had required chemicals for treatment. Improvements to the purity of water in turn improve public and environmental health.

Extended Membrane Lifespan: Membranes designed with use-case and operational situations in mind will benefit from increased durability and resistance to fouling, scaling, and chemical damage. This leads to longer membrane lifespan, reducing the frequency of replacements and maintenance, and decreasing waste as well as maintenance costs.

Enhanced Efficiency and Customization: An AI-driven approach for determining membrane properties based on task characteristics and manufacturing context allows for highly efficient and customized membrane production. This advantage may be particularly valuable in diverse industrial settings, where fluid characteristics can vary greatly.

Advanced Manufacturing Techniques: The use of 3D printing for membrane production enables quick and easy membrane manufacturing with complete control over the manufacturing process and the end result, allowing for custom-tailored membranes that perform better than non-tailored mass-market membranes.

Broad Industrial Applications: Such a system's adaptability makes it suitable for various industries, from pharmaceuticals to food and beverage, where purity levels are critical.

According to at least one embodiment, the invention is a processor-implemented method for manufacturing a semi-permeable membrane for purifying a fluid through reverse osmosis, the method comprising modeling a performance of several semi-permeable membrane configurations within a simulation of a fluid flowing through a reverse osmosis system, based on a plurality of fluid properties, flow characteristics, and task criteria associated with a fluid purification task; calculating, based on the modeling, a shear stress exerted by the simulated fluid on the semi-permeable membrane configurations; generating a membrane design for the semi-permeable membrane based on the modeling, wherein the membrane design comprises a material selected based on the calculated shear stress; and manufacturing a semi-permeable membrane of the selected material using a 3D printer, based on the membrane design.

According to at least one embodiment, the invention is a computer system for performing a fluid purification task using a semi-permeable membrane for reverse osmosis, the computer system comprising sensors disposed within a fluid channel comprising valves and a semi-permeable membrane, processors, computer-readable memories, a computer-readable tangible storage medium, and program instructions stored on at least one tangible storage medium for execution by at least one of the processors via at least one of the memories, wherein the computer system is capable of performing a method comprising monitoring, by the sensors, a plurality of fluid properties and flow characteristics of a fluid flowing through the fluid channel in real time; calculating, based on the fluid properties and flow characteristics, a shear stress exerted on the semi-permeable membrane by the fluid in real time; and responsive to the shear stress falling outside of a stress threshold, operating the one or more valves to alter the flow characteristics to raise or lower the shear stress to fall within the stress threshold.

References in the specification to “one embodiment”, “other embodiment”, “another embodiment”, “an embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure, or characteristic is described in connection with an embodiment, it is understood that it is within the knowledge of one skilled in the art to affect such feature, structure or characteristic in connection with other embodiments whether or not explicitly described.

For purposes of the description hereinafter, the terms “upper”, “lower”, “right”, “left”, “vertical”, “horizontal”, “top”, “bottom”, and derivatives thereof shall relate to the disclosed structures and methods, as oriented in the drawing figures. The terms “overlying”, “atop”, “over”, “on”, “positioned on” or “positioned atop” mean that a first element is present on a second element wherein intervening elements, such as an interface structure, may be present between the first element and the second element. The term “direct contact” means that a first element and a second element are connected without any intermediary conducting, insulating, or semiconductor layers at the interface of the two elements.

In the interest of not obscuring the presentation of the embodiments of the present invention, in the following detailed description, some of the processing steps, materials, or operations that are known in the art may have been combined together for presentation and for illustration purposes and in some instances may not have been described in detail. Additionally, for brevity and maintaining a focus on distinctive features of elements of the present invention, description of previously discussed materials, processes, and structures may not be repeated with regard to subsequent Figures. In other instances, some processing steps or operations that are known may not be described. It should be understood that the following description is rather focused on the distinctive features or elements of the various embodiments of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to determine membrane properties which a semi-permeable membrane must possess to perform a fluid purification task, design a non-permeable membrane possessing the necessary membrane properties, and 3D-print a customized membrane based on the design.

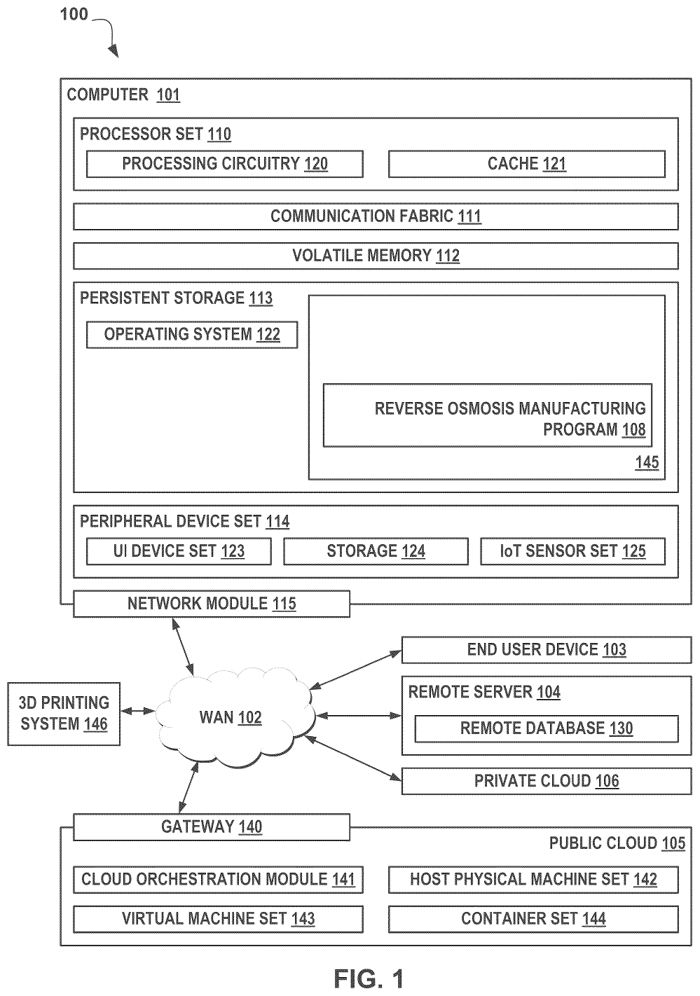

Referring now to FIG. 1, computing environment 100 contains an example of an environment for the execution of at least some of the computer code involved in performing the inventive methods, such as code block 145, which may comprise reverse osmosis manufacturing program 108. In addition to code block 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 145, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 145 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in code block 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the 3D printing system 146 may be a specialized system integrated into, in communication with, or otherwise operatively connected to the computing environment 100, and which may be operated, commanded, or otherwise controlled by reverse osmosis manufacturing program 108 to manufacture semi-permeable membranes for performing fluid purification tasks. The 3D printing system 146 may comprise one or more additive manufacturing devices, or 3D printers, designed to create 3D physical objects by depositing successive layers of material on a build platform, and which is capable of manufacturing a semi-permeable membrane from a provided membrane design. The 3D printing system 146 may comprise high-resolution nozzles capable of extruding materials at very fine resolutions (down to micrometers) to achieve the precise pore sizes needed for reverse osmosis membranes, and may be equipped with multi-material print heads capable of handling high-viscosity materials and able to print different materials simultaneously. In embodiments, the 3D printing system 146 may comprise one or more motion systems capable of moving a print head with high accuracy and precision, such as CoreXY, to allow for minimal vibration. In embodiments, the 3D printing system 146 may comprise one or more light beam penetration monitoring devices, which may be devices that uses light beams to penetrate the object being printed by the 3D printing system 146 while the object is under construction, in order to provide real-time feedback on the quality and properties of the printed object. The light beam penetration monitoring device may comprise one or more coherent light sources, such as a laser, and one or more optical sensors capable of recording how the light interacts with the 3D printed object.

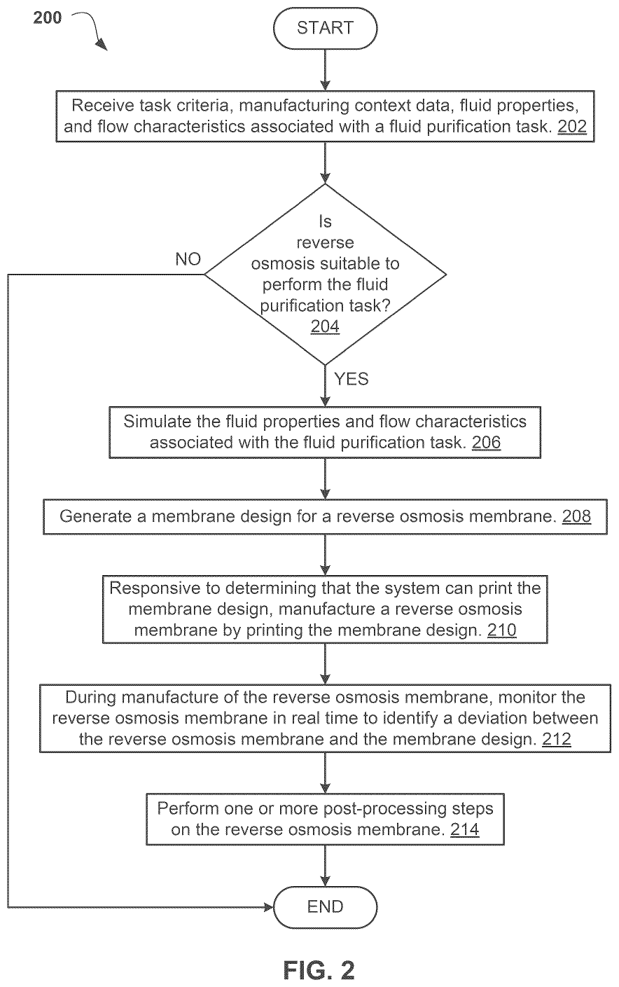

According to the present embodiment, the reverse osmosis manufacturing program 108 may be a program enabled to determine membrane properties which a semi-permeable membrane must possess to perform a fluid purification task, design a non-permeable membrane possessing the necessary membrane properties, and 3D-print a customized membrane based on the design. The reverse osmosis manufacturing program 108 may, when executed, cause the computing environment 100 to carry out an reverse osmosis manufacturing process 200. The reverse osmosis manufacturing process 200 may be explained in further detail below with respect to FIG. 2. In embodiments of the invention, the reverse osmosis manufacturing program 108 may be stored and/or run within or by any number or combination of devices including computer 101, end user device (EUD) 103, remote server 104, private cloud 106, and/or public cloud 105, peripheral device set 114, and/or on any other device connected to WAN 102. Furthermore, reverse osmosis manufacturing program 108 may be distributed in its operation over any number or combination of the aforementioned devices.

Referring now to FIG. 2, an operational flowchart illustrating a reverse osmosis manufacturing process 200 is depicted according to at least one embodiment. At 202, the reverse osmosis manufacturing program 108 may receive task criteria, manufacturing context data, fluid properties, and flow characteristics associated with a fluid purification task. The reverse osmosis system may be a system designed to remove contaminants from a fluid using reverse osmosis.

The fluid purification task may be a functionality that a reverse osmosis system is designed to achieve, such as removing 95-99% percent of dissolved salts, particles, colloids, organics, bacteria, and pyrogens from feedwater to produce 100 gallons of drinking water per minute. The task criteria may be the specific parameters governing successful performance of the fluid purification task, including efficiency targets of the reverse osmosis system or components of the reverse osmosis system, quality goals for the permeate, longevity targets for equipment comprising the reverse osmosis system, goals for amount of fluid processed, et cetera. For example, the task criteria may include 1) achieving and maintaining a 95-99% reduction of dissolved salts particles, colloids, organics, bacteria, and pyrogens from feedwater; 2) generating 100 gallons of drinking water per minute; and 3) requiring no more than 3 annual replacements of the semi-permeable membrane. The task criteria may also comprise the physical hardware available for performing the fluid purification task, including the size, width, location, orientation, and configuration of pipes and conduits, pumps, valves, membranes, et cetera.

The manufacturing context data may comprise data describing the manufacturing capabilities locally available to the reverse osmosis manufacturing program 108. The manufacturing context data may include the number, quality, capabilities, operational status, et cetera of the 3D printers comprising the 3D printing system 146, as well as the amount and types of material available to the 3D printing system 146.

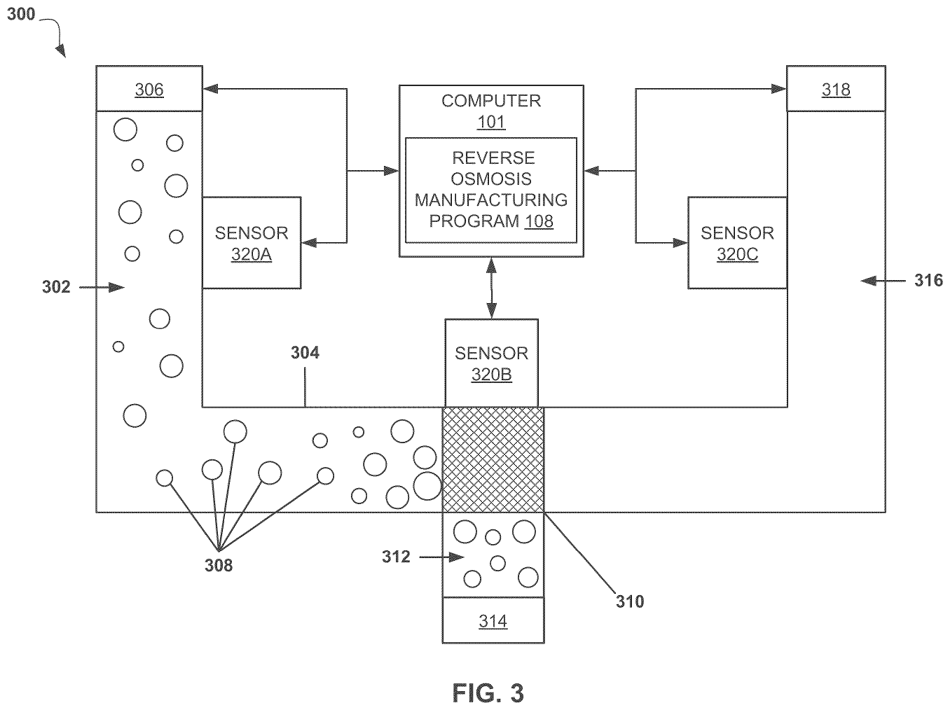

The fluid properties may be the chemical and physical properties of the fluids associated with the fluid purification task. The fluid properties may include the chemical composition of the fluid to be purified, the types, proportions, and chemical makeup of contaminants in the fluid, the temperature of the fluid, the presence and chemical properties of impurities and solutes, et cetera. The flow characteristics may be data regarding the kinetic parameters of fluid flow through the conduits of the reverse osmosis system, such as flow speed, turbulence, pressure, volume, et cetera. In embodiments, the fluid properties and flow characteristics may be measured in real time by a variety of sensors connected to reverse osmosis manufacturing program 108. The sensors may be discussed in greater detail below with respect to FIG. 3. In embodiments, the fluid properties and flow characteristics may be pre-provided to the reverse osmosis manufacturing program 108 from an external source, and/or may be inferred from the physical characteristics of the reverse osmosis system as may be provided in the task criteria.

In embodiments, for example where the fluid properties, the flow characteristics, and/or the manufacturing context data are being gathered in real time via sensors disposed within the reverse osmosis system, the sensors may be already actively monitoring the fluid, or the required sensors for data collection on the fluid may be installed responsive to the reverse osmosis manufacturing program 108 receiving the task criteria. The sensors and data may then be re-used at a future date when there is a need for a new membrane and/or a new fluid purification task. In embodiments, the task criteria, manufacturing context data, fluid properties, and flow characteristics may not include real-time sensor data, and may include data gathered from a historic knowledge corpus associated with similar purification task criteria and fluid flow/characteristics. In embodiments, for example where the flow characteristics and task criteria do not dynamically change over time, the manufacturing context data, fluid properties, and flow characteristics may be gathered over a period of time specifically for the purpose of creating a membrane for the fluid purification task and manually entered into reverse osmosis manufacturing program 108. In embodiments, the reverse osmosis manufacturing program 108 may operate without detailed information regarding the flow characteristics, fluid properties, and/or manufacturing context data, through task specification and by leveraging historic data of other similar fluids. However, such limited operation will cause a drop in the accuracy and performance of the membrane.

At 204, the reverse osmosis manufacturing program 108 determines whether reverse osmosis is suitable to perform the fluid purification task. Here, the reverse osmosis manufacturing program 108 may consider the type of fluid to be purified and the type of contaminants to be removed according to the fluid properties, the flow characteristics, and the desired purification efficiency and quality according to the task criteria to determine whether a reverse osmosis process is capable of purifying the fluid of the contaminants under the specified flow characteristics to the desired level of efficiency and quality. The reverse osmosis manufacturing program 108 may consult a corpus of reverse osmosis data, which may comprise historical data regarding past reverse osmosis systems and their effectiveness under various conditions. In embodiments, the reverse osmosis manufacturing program 108 may utilize a machine learning model, such as a deep neural network trained on, for example, the corpus of reverse osmosis data in order to identify connections between different fluid properties, flow characteristics, and the performance of reverse osmosis processes. The machine learning model may receive as input the fluid properties, flow characteristics, and task criteria, and output a binary determination that reverse osmosis is suitable or not suitable for carrying out the fluid purification task.

Reverse osmosis may be suitable for use only under particular conditions, and the machine learning model may, using the fluid properties, flow characteristics, and task criteria, identify whether the prevailing conditions fall within nominal ranges where reverse osmosis is suitable. In embodiments, for example, the machine learning model may determine that reverse osmosis is not suitable if the flow rate exceeds a maximum threshold or if the amount of fluid to be processed exceeds a certain threshold quantity; a large quantity of contaminants can clog the membranes quickly, and therefore reverse osmosis may not be suitable if too high a volume of fluid is passing through the membrane, either due to a speed of the fluid or the quantity. Reverse osmosis also requires a minimum fluid pressure, without which reverse osmosis may not be suitable. Fluid temperature in conjunction with available materials for the membrane can affect suitability, if for example available materials degrade under the prevailing fluid temperatures or are otherwise damaged or rendered less efficient at the task of performing reverse osmosis. Furthermore, budget constraints in association with the designed membrane may be relevant to suitability, as reverse osmosis membranes may be more expensive than other pollutant separation methods. In embodiments, for example where reverse osmosis is not suitable, the reverse osmosis manufacturing program 108 may select one or more alternative methods. Alternative methods may include distillation, activated carbon, ultrafiltration.

According to at least one implementation, if the reverse osmosis manufacturing program 108 determines that reverse osmosis is not suitable to perform the fluid purification task (step 204, “NO” branch), the reverse osmosis manufacturing program 108 may terminate. If the reverse osmosis manufacturing program 108 determines that reverse osmosis is suitable to perform the fluid purification task (step 204, “YES” branch), the reverse osmosis manufacturing program 108 may continue to step 206 to generate a membrane design for a reverse osmosis membrane. In embodiments, based on factors such as the volume of fluids to be processed with reverse osmosis, the flow rate of the fluid, and the desired quality of the fluid, the reverse osmosis manufacturing program 108 may utilize a machine learning model to determine whether multi-stage reverse osmosis is necessary.

At 206, the reverse osmosis manufacturing program 108 may simulate the fluid properties and flow characteristics associated with the fluid purification task. Here, the reverse osmosis manufacturing program 108 may create a virtual model of the reverse osmosis system, and may use fluid dynamics equations and simulation software, as well as pre-provided fluid databases comprising extensive information on fluid characteristics and properties, to model the flow of the specified fluids through the virtual representation of the reverse osmosis system based on the fluid properties and the flow characteristics. The reverse osmosis manufacturing program 108 may insert virtual representations of various different membrane configurations into the simulation to model the performance of membranes of each of a number of pre-provided shapes sized to fit the simulated reverse osmosis system. The pre-provided shapes may comprise configurations such as flat sheets, hollow tubes, et cetera. The reverse osmosis manufacturing program 108 may calculate the force exerted on each of the simulated membrane shapes by the simulated fluid based on the velocity and viscosity of the simulated fluid, and the pressure drop across the simulated membrane; the reverse osmosis manufacturing program 108 may calculate the shear stress by dividing the force by the cross-sectional area of the simulated membrane that is in contact with the simulated fluid.

In embodiments of the invention, the reverse osmosis manufacturing program 108 may perform the simulation utilizing enhanced computational fluid dynamics (CFD) models, where the enhanced CFD models incorporate the effects of temperature and pressure variations on fluid properties and model the interaction of different fluid components with a reverse osmosis membrane at a molecular level, providing insights into potential fouling or chemical interactions. In embodiments, for example where the fluid is a non-Newtonian fluid, the enhanced CFD models may allow for simulation of the fluid as they are capable of simulating non-Newtonian fluids.

At 208, the reverse osmosis manufacturing program 108 may generate a membrane design for a reverse osmosis membrane. The reverse osmosis manufacturing program 108 may generate a membrane design by selecting, for example, a shape, material, size, thickness, and pore size. The reverse osmosis manufacturing program 108 may select a shape for the membrane design by choosing the pre-provided membrane shape of those modeled in the simulation that exhibited the highest performance. The reverse osmosis manufacturing program 108 may select a size based on the dimensions of the reverse osmosis system where the membrane is to be installed. The reverse osmosis manufacturing program 108 may select a pore size based on the desired efficiency, and/or the chemical and physical properties of the contaminants to be separated out, as described in the fluid properties.

In embodiments, the reverse osmosis manufacturing program 108 may select a material for the membrane design by consulting a pre-provided materials database comprising a list of materials suitable for the manufacture of semi-permeable membranes and the physical and chemical properties of each material, including strength, solubility, tolerance to various chemicals such as oxidizers, susceptibility to scaling, fouling, mechanical and chemical damage, et cetera. The reverse osmosis manufacturing program 108 may select a material that is strong enough to withstand the shear forces identified in the simulation, tolerant of chemicals known to be present in the fluid, and/or which is available to 3D printing system 146.

In embodiments, the reverse osmosis manufacturing program 108 may determine a thickness of the membrane design based on, for example, the selected material, the selected shape, the shear forces associated with the selected membrane shape based on the simulation, desired efficiency, and desired longevity. A thicker membrane design is better able to withstand the shear forces and lasts longer before needing to be replaced, but a thinner membrane is more efficient. In embodiments, the reverse osmosis manufacturing program 108 may select a thickness that is strong enough to withstand the shear forces but no thicker. In embodiments, the reverse osmosis manufacturing program 108 may select a thickness that considers established safety margins in force estimation to ensure the membrane design can withstand the shear stress without damage. In embodiments, the reverse osmosis manufacturing program 108 may utilize a machine learning model trained to select a thickness for the membrane design that represents the intersection of strength, longevity, and efficiency.

Once the reverse osmosis manufacturing program 108 has selected at least a material, a pore size, a shape, size, and thickness, the reverse osmosis manufacturing program 108 may create a membrane design of the selected pore size, shape, size, and thickness, where the membrane design is a 3D virtual model of the membrane to be manufactured.

At 210, the reverse osmosis manufacturing program 108 may, responsive to determining that the system can print the membrane design, manufacture a reverse osmosis membrane by printing the membrane design. Based on the identified position within the industrial manufacturing workflow where the reverse osmosis membranes are intended to be installed, as well as the specific design and shape of the reverse osmosis membranes, the reverse osmosis manufacturing program 108 may determine whether the 3D printing system 146 can manufacture the membrane from the membrane design. The reverse osmosis manufacturing program 108 may determine whether the 3D printing system 146 can manufacture the membrane by querying the 3D printing system 146 to determine whether 3D printing system 146 possesses operational 3D printers with the technical specifications necessary to create pores of the selected size, and to determine whether enough of the selected material is available. If a 3D printer is operational and capable of performing the request, and has enough of the selected material to do so, the reverse osmosis manufacturing program 108 may provide the 3D printing system 146 with the membrane design, and may order or operate the 3D printing system 146 to manufacture the membrane from the membrane design. In embodiments, for example where the selected material is not available, the reverse osmosis manufacturing program 108 may re-design the membrane design to use a material that is available to 3D printing system 146.

At 214, the reverse osmosis manufacturing program 108 may, during manufacture of the reverse osmosis membrane, monitor the reverse osmosis membrane in real time to identify a deviation between the reverse osmosis membrane and the 3D model. The reverse osmosis manufacturing program 108 may utilize sensors and imaging technology to provide real-time monitoring of the membrane as the membrane is being printed to identify any deviations from the membrane design. The reverse osmosis manufacturing program 108 may, for example, use an in-process monitoring system using light beams, comprising a light beam penetration monitoring device, to assess properties of the membrane including pore size and membrane thickness alignment in real time during the printing process. In embodiments, where a deviation is identified, the reverse osmosis manufacturing program 108 may transmit an alert to a mobile device associated with a user. The reverse osmosis manufacturing program 108 may use the deviation to notify the user, via the transmitted alert, of performance risks in using the printed membrane due to its deviation from the intended design. In embodiments, the reverse osmosis manufacturing program 108 may trigger the 3D print process to stop if the deviation exceeds the deviation thresholds, to save printing material; for example, where a percentage is too large for the printed pore size, the reverse osmosis manufacturing program 108 may trigger the 3D printing system 146 to cease printing so as to avoid wasting printing material on a membrane with pores that are too large.

At 216, the reverse osmosis manufacturing program 108 may perform one or more post-processing steps on the reverse osmosis membrane. Here, the reverse osmosis manufacturing program 108 may execute or trigger post-processing steps, such as surface treatment or additional coatings, to modify the pore size and enhance performance, ensuring the membrane's resistance to fouling, chemical compatibility, and pressure resistance.

Referring now to FIG. 3, an exemplary reverse osmosis system 300 is depicted according to at least one embodiment. Here, a feed fluid 302 enters the fluid channel 304 through an entry valve 306. The flow of the feed fluid 302 through the fluid channel 304 may be controlled by a pump. The feed fluid 302 here comprises a fluid mixed with contaminants 308. The feed fluid 302 flows down the fluid channel 304 until it encounters a semi-permeable membrane 310, where, through reverse osmosis, the contaminants 308 are separated from the fluid; through a cross-filtration process, the separated contaminants 308 are routed into a reject stream 312, or concentrate, where they are routed out of the fluid channel 304 through valve 314. The semi-permeable membrane 310 may have been designed and/or manufactured via a reverse osmosis manufacturing process 200. The purified fluid 316, or permeate, flows through the fluid channel 304 and exits through valve 318. Those skilled in the art would appreciate that while a simplified system is depicted here for illustrative convenience, embodiments of the present invention may comprise any number or combination of fluid channels, valves, membranes, computers, sensors, et cetera.

Computer 101, running all or part of reverse osmosis manufacturing program 108, may be in communication with a plurality of sensors 320A, 320B, 320C. The sensors 320A, 320B, 320C may be part of IoT Sensor Set 125, and may comprise devices for measuring flow characteristics such as flow speed, turbulence, pressure drop, et cetera; sensors 320A, 320B, 320C for measuring flow characteristics may comprise any number or combination of, for example, ultrasonic flow meters for non-invasive flow rate measurement, capacitive or piezoelectric pressure sensors for high-precision pressure monitoring, laser Doppler velocimeters or particle image velocimeters for detailed velocity profiling, et cetera.

The sensors 320A, 320B, 320C may additionally or alternatively comprise devices for measuring fluid properties, such as the chemical composition of the feed fluid 302 including the chemical comprising the fluid and the proportion of contaminants 308 to fluid, the presence and chemical properties of impurities, solutes, and contaminants 308 in the fluid, the chemical properties of the concentrate 312, the purity of the permeate 316, the temperature of the fluid, et cetera. The sensors 320A, 320B, 320C may comprise any number or combination of, for example, conductivity sensors to monitor the ionic concentration, pH sensors to detect changes in the fluid's acidity or alkalinity, which might impact membrane performance, turbidity sensors to measure the clarity of the fluid and detect particulate matter, velocity probes to understand the distribution of fluid velocities within the reverse osmosis system 300, and thermometers to measure the temperature of the flowing fluid, as temperature can impact the properties of the fluid and the efficiency of the purification process.

In embodiments, one or more sensors 320A may be integrated with the fluid channel 304 at one or more points before the semi-permeable membrane 310, so as to measure flow characteristics and/or fluid properties of the feed fluid 302. In embodiments, one or more sensors 320B may be integrated with the segment of the fluid channel 304 at the semi-permeable membrane 310, so as to measure flow characteristics and/or fluid properties of the fluids 302, 312, 316 as they pass through the membrane 310, and thereby enable reverse osmosis manufacturing program 108 to analyze the performance of the membrane 310 and the effects of the fluids 302, 312, 316 on the membrane 310. In embodiments, one or more sensors 320C may be integrated with the segment of the fluid channel 304 after the semi-permeable membrane 310 where permeate 316 is routed from the membrane 310 to valve 318, so as to measure flow characteristics and/or fluid properties of the permeate 316. In embodiments, one or more sensors 320A, 320B, 320C may be integrated with the segment of the fluid channel 304 after the semi-permeable membrane 310 where concentrate 312 is routed from the membrane 310 to valve 314, so as to measure flow characteristics and/or fluid properties of the concentrate 312.

In embodiments of the invention, the reverse osmosis manufacturing program 108 may monitor the flow characteristics and fluid properties of the fluids 302, 304, 316 within the reverse osmosis system 300 before and after the reverse osmosis membrane in real time to dynamically assess the forces acting upon the membrane 310. For example, the reverse osmosis manufacturing program 108 may calculate the pressure drop across the membrane 310; the force exerted on the membrane 310 is a function of the pressure drop and will determine the impact of fluid velocity on the membrane 310. Accordingly, the reverse osmosis manufacturing program 108 may calculate the pressure difference across the membrane 310 using the pressure measurements comprising the flow characteristics. The force exerted on the membrane 310 is also a function of fluid velocity; high-velocity flows may apply greater force on the membrane due to increased momentum. The reverse osmosis manufacturing program 108 may therefore calculate the effects of fluid velocity on the force exerted on the membrane 310. Additionally, the reverse osmosis manufacturing program 108 may consider the viscosity of the fluids 302, 312, 316 in assessing the force exerted on the membrane 310, as viscous fluids 302, 312, 316 can create additional resistance and forces on the membrane.

In embodiments, responsive to determining the force exerted on the membrane 310 by the fluids 302, 312, 316, the reverse osmosis manufacturing program 108 may calculate the cross section of the surface area of the reverse osmosis membrane 310 that is in contact with the fluid 302, 312, 316; the force is distributed across this area to yield the shear stress exerted by the fluid 302, 312, 316 on the membrane 310.

In embodiments, the reverse osmosis system 300 may comprise an adaptive control system, wherein the reverse osmosis manufacturing program 108 is operatively connected to the valves 306, 314, 318 and is capable of incrementally opening and closing the valves 306, 314, 318 to adjust flow characteristics of the fluids 302, 312, 316. The reverse osmosis manufacturing program 108 may monitor the force and shear stress on the membrane 310 in real time, and may dynamically operate the valves 306, 314, 318 to increase or decrease flow rate, velocity, pressure, et cetera of the fluids 302, 312, 316 in order to maintain the force and/or shear stress exerted on the membrane 310 within a stress threshold. For example, responsive to determining that the force exceeds the stress threshold, the reverse osmosis manufacturing program 108 may reduce the aperture of valve 306 and valve 318 to reduce the volume of fluids 302, 312, 316 moving through the fluid channel 304 and thereby reduce the force on the membrane 310. Conversely, responsive to determining that the force on the membrane 310 has fallen below the threshold, the reverse osmosis manufacturing program 108 may increase the aperture of valve 306 and valve 318 to increase the volume of fluids 302, 312, 316 and thereby increase the force on the membrane 310.

In embodiments, the stress threshold may comprise a range of force values representing sustainable operation, below which the efficiency of the membrane 310 drops, and above which the longevity of the membrane 310 is impacted. The stress threshold may be pre-provided to reverse osmosis manufacturing program 108, and/or may be created and/or dynamically adjusted based on feedback. The stress threshold may be based closely on the material, shape, and thickness of the membrane 310, which, among other things, dictate how much shear stress the membrane 310 can withstand. In embodiments, the adaptive control system may comprise overpressure protection mechanisms to prevent membrane damage, and/or automatic shutdown protocols in case of sensor failure or detection of hazardous conditions.

In embodiments, the adaptive control system may comprise a user interface for monitoring and control that displays real-time data and analytics, including visualizations of fluid dynamics and membrane conditions based on the real-time data from the sensors 320A, 320B, 320C displayed on display devices such as a display screen of UI device set 123, and/or including user-customizable alerts and notifications regarding system anomalies or maintenance requirements identified based on the real-time data from the sensors 320A, 320B, 320C. In embodiments, the adaptive control system may implement predictive maintenance schedules based on the calculated shear stress and the flow characteristics and fluid properties.

In embodiments, the reverse osmosis manufacturing program 108 may utilize machine learning algorithms to predict changes in fluid properties based on historical and real-time fluid properties and flow characteristics gathered by the sensors 320A, 320B, 320C. The reverse osmosis manufacturing program 108 may operate the adaptive control system and/or transmit alerts to mobile devices associated with human users pre-emptively, to modify the flow characteristics in response to a predicted change in fluid properties. The reverse osmosis manufacturing program 108 may employ data fusion techniques to integrate readings from any number or combination of sensing devices within the reverse osmosis system 300, including sensors 320A, 320B, 320C, to build a comprehensive understanding of fluid behavior within the reverse osmosis system 300.

It may be appreciated that FIGS. 2-3 provide only illustrations of individual implementations and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for manufacturing a semi-permeable membrane for purifying a fluid through reverse osmosis, the method comprising:
modeling a performance of one or more semi-permeable membrane configurations within a simulation of a fluid flowing through a reverse osmosis system, based on a plurality of fluid properties, flow characteristics, and task criteria associated with a fluid purification task;
calculating, based on the modeling, a shear stress exerted by the simulated fluid on the one or more semi-permeable membrane configurations;
generating a membrane design for the semi-permeable membrane based on the modeling, wherein the membrane design comprises a material selected based on the calculated shear stress; and
manufacturing a semi-permeable membrane of the selected material using a 3D printer, based on the membrane design.

2. The method of claim 1, wherein the membrane design further comprises a configuration of the one or more semi-permeable membrane configurations with a highest performance.

3. The method of claim 1, wherein the material is further selected based on a tolerance for one or more chemicals comprising the fluid.

4. The method of claim 1, wherein the material is further selected from one or more materials available to the 3D printer.

5. The method of claim 1, responsive to determining that the selected material is not available to the 3D printer, re-designing the membrane design to comprise a material that is available to the 3D printer.

6. The method of claim 1, the method further comprising:
identifying, by a light beam penetration monitoring device, one or more deviations between the semi-permeable membrane and the membrane design while the semi-permeable membrane is being printed.

7. The method of claim 1, performing one or more post-processing steps on the semi-permeable membrane.

8. A computer system for performing a fluid purification task using a semi-permeable membrane for reverse osmosis, the computer system comprising:
one or more sensors disposed within a fluid channel comprising one or more valves, one or more semi-permeable membranes, one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
monitoring, by the one or more sensors, a plurality of fluid properties and flow characteristics of a fluid flowing through the fluid channel in real time;
calculating, based on the fluid properties and flow characteristics, a shear stress exerted on the semi-permeable membrane by the fluid in real time; and
responsive to the shear stress falling outside of a stress threshold, operating the one or more valves to alter the flow characteristics to raise or lower the shear stress to fall within the stress threshold.

9. The computer system of claim 8, wherein the stress threshold is determined based on a selected material comprising the semi-permeable membrane.

10. The computer system of claim 8, further comprising:
responsive to the shear stress falling outside of a stress threshold, transmitting one or more alerts to a mobile device associated with a user.

11. The computer system of claim 8, further comprising:
predicting, by a machine learning model, a change in future fluid properties based on the fluid properties, the flow characteristics, and historical data; and
responsive to predicting that the shear stress will fall outside of a stress threshold based on the predicted change in the future fluid properties, operating the one or more valves to alter the flow characteristics to raise or lower the shear stress to fall within the stress threshold.

12. The computer system of claim 8, further comprising:
implementing a predictive maintenance schedule based on the calculated shear stress, the flow characteristics, and the fluid properties.

13. The computer system of claim 8, wherein at least one pressure sensor of the one or more sensors is disposed within the fluid channel prior to the semi-permeable membrane, and at least another pressure sensor of the one or more sensors is disposed within the fluid channel after the semi-permeable membrane, and wherein calculating the shear stress further comprises:
calculating a pressure drop across the semi-permeable membrane based on one or more readings from the pressure sensors.

14. The computer system of claim 8, wherein the one or more sensors record a performance of the semi-permeable membrane and a plurality of effects of the fluid on the semi-permeable membrane, and wherein the system further comprises:
updating a machine learning model used to construct the semi-permeable membrane with the performance and the plurality of effects.

15. A computer program product for manufacturing a semi-permeable membrane for purifying a fluid through reverse osmosis, the computer program product comprising:
one or more computer-readable tangible storage medium and program instructions stored on at least one of the one or more tangible storage medium, the program instructions executable by a processor to cause the processor to perform a method comprising:
modeling a performance of one or more semi-permeable membrane configurations within a simulation of a fluid flowing through a reverse osmosis system, based on a plurality of fluid properties, flow characteristics, and task criteria associated with a fluid purification task;
calculating, based on the modeling, a shear stress exerted by the simulated fluid on the one or more semi-permeable membrane configurations;
generating a membrane design for the semi-permeable membrane based on the modeling, wherein the membrane design comprises a material selected based on the calculated shear stress; and
manufacturing a semi-permeable membrane of the selected material using a 3D printer, based on the membrane design.

16. The computer program product of claim 15, wherein the membrane design further comprises a configuration of the one or more semi-permeable membrane configurations with a highest performance.

17. The computer program product of claim 15, wherein the material is further selected based on a tolerance for one or more chemicals comprising the fluid.

18. The computer program product of claim 15, wherein the material is further selected from one or more materials available to the 3D printer.

19. The computer program product of claim 15, responsive to determining that the selected material is not available to the 3D printer, re-designing the membrane design to comprise a material that is available to the 3D printer.

20. The computer program product of claim 15, the method further comprising:
identifying, by a light beam penetration monitoring device, one or more deviations between the semi-permeable membrane and the membrane design while the semi-permeable membrane is being printed.
